(19) United States
(12) Patent Application Publication
(10) Pub. No.: US 2006/0034077 A1
(43) Pub. Date: Feb. 16, 2006

(54) White light bulb assembly using LED as a light source

(76) Inventor: Tsu-Kang Chang, Taipei (TW)

Correspondence Address: Jackson Walker L.L.P., Suite 2100, 112 E. Pecan Street, San Antonio, TX, 78205, US

(21) Appl. No.: 10/915,304

(22) Filed: Aug. 10, 2004

(51) Int. Cl. F21V 17/06

(52) U.S. Cl. 362/227; 362/800; 362/455; 362/448; 362/437; 362/347; 362/339; 362/340; 362/238

(57) ABSTRACT

A white light bulb assembly includes a cylindrical body with an annular projection extending from a bottom face of the cylindrical body, a bulb covering securely mounted on top of the cylindrical body, and multiple light emitting diodes provided inside the bulb covering to electrically connect to the annular projection and a circuit board located inside the bulb covering. The bulb covering has multiple first grooves defined in an outer circumference of the bulb covering and multiple second grooves defined in an inner circumference of the bulb covering to reflect and refract light from the light emitting diodes. The first grooves intersect the second grooves in an angle so as to reinforce the reflection and refraction of light.

### BACKGROUND OF THE INVENTION

1. Field of the Invention

The present invention relates to a white light bulb assembly, and more particularly to a white light assembly with multiple light emitting diodes inside the light bulb cover as a light source to allow light from the LEDs to emit out of the light bulb cover from all directions.

2. Description of Related Art

As the concern of the preservation of the environment continuously increases, people are seeking alternate energy sources to replace the polluting energy sources, e.g. oil, so as to maintain our mother land, the earth, habitable. One solution is to use hydropower as an eternal energy source due to the long lasting supply of water all over the world. This indeed is a way of solving air polluting problems for those electrical appliances fixed to a location. However, for those electrical appliances that need to be moved around, such as lanterns or outdoor illuminating equipment, hydropower seems not able to provide portable energy to sustain normal function of the appliances. In order to solve the problems, batteries are introduced to the market to provide portable energy to meet the needs. Still, when energy in the battery is run out, the used battery will cause a different environmental hazard due to the leakage of hazardous liquid in the processes of rusting and decomposing.

When technology in solar energy developed, solar panels became the most effective solution to provide portable energy and to preserve the environment at the same time.

In the early state of the development of solar energy, there were two different illuminating elements to be incorporated with solar panels to emit light; one is the fluorescent tube and the other is the light emitting diode.

When the fluorescent tube is used, very bulky solar panels are required to convert sufficient energy to drive the fluorescent tube. Furthermore, the life span of the fluorescent tube is about 3,000 to 8,000 hours, which is quite short in outdoor facilities.

In reference to the light emitting diode (LED), due to its compact size and intensified brightness, the LED is the most essential element in outdoor equipment. Despite the advantages the LED has, drawbacks do occur in the usage of LED as a light source. First, the light from the LED is directly emitted in a forward pattern instead of a scattered pattern as that of the fluorescent tube. second, an additional device is required if the LED, as a light source, is employed.

To overcome the shortcomings, the present invention tends to provide an improved light bulb assembly to mitigate the aforementioned problems.

### SUMMARY OF THE INVENTION

The primary objective of the present invention is to provide an improved light bulb assembly using LEDs as an illumination source to emit light in a scattered pattern.

In order to accomplish the objective, the light bulb assembly of the present invention includes a cylindrical body with a thread formed on an outer circumference thereof, a bulb covering securely mounted on top of the cylindrical body, multiple light emitting diodes mounted inside the bulb covering and a circuit board electrically connected to the LEDs and the cylindrical body. Furthermore, the bulb covering has multiple longitudinal grooves defined on the outer circumference and latitudinal grooves defined in an inner circumference of the bulb covering such that the light from the LEDs will be refracted and scattered to show a scattered pattern.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the white light bulb assembly of the present invention;

FIG. 2 is a cross sectional plan view of the white light bulb assembly in FIG. 1;

FIG. 3 is a plan view showing the contour of the white light bulb assembly; and

FIG. 4 is a schematic view showing the application of the white light bulb assembly with solar panels.

### DETAILED DESCRIPTION OF THE PREFERRED EMBODIMENT

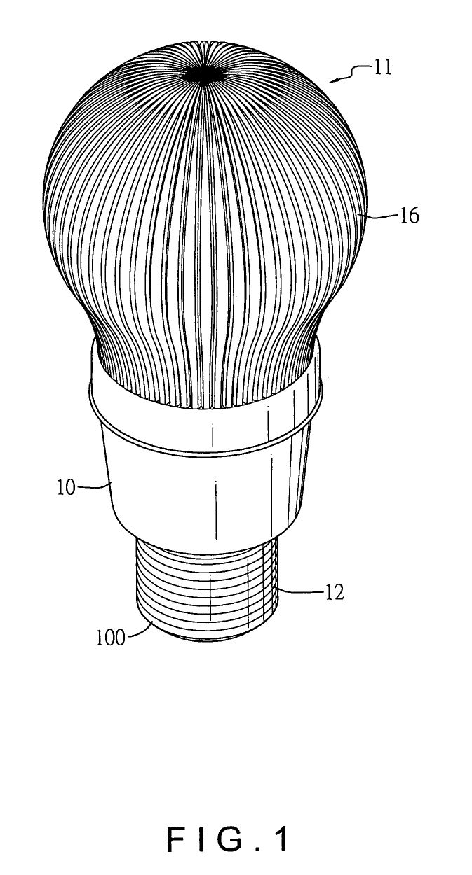

With reference to FIG. 1, it is noted that the white light bulb assembly in accordance with the present invention includes a cylindrical body (10) with an annular projection (100) extending out from a bottom face of the cylindrical body (10) and having a threading (12) formed on an outer circumference of the annular projection (100). A bulb covering (11) is securely mounted on top of the cylindrical body (10) and provided with multiple longitudinal grooves (16) defined in an outer periphery of the bulb covering (11).

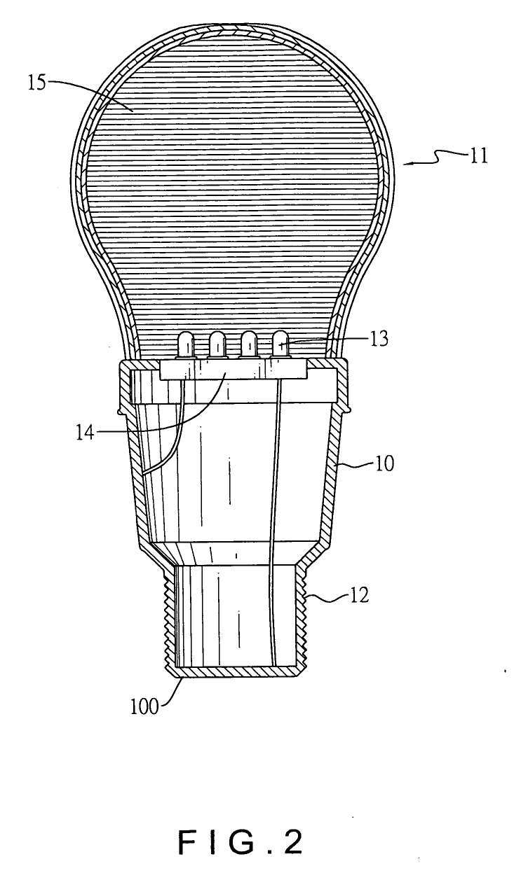

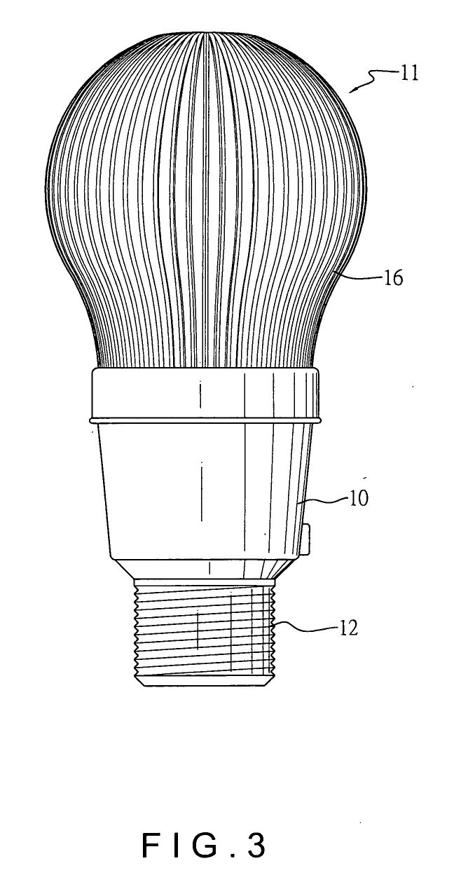

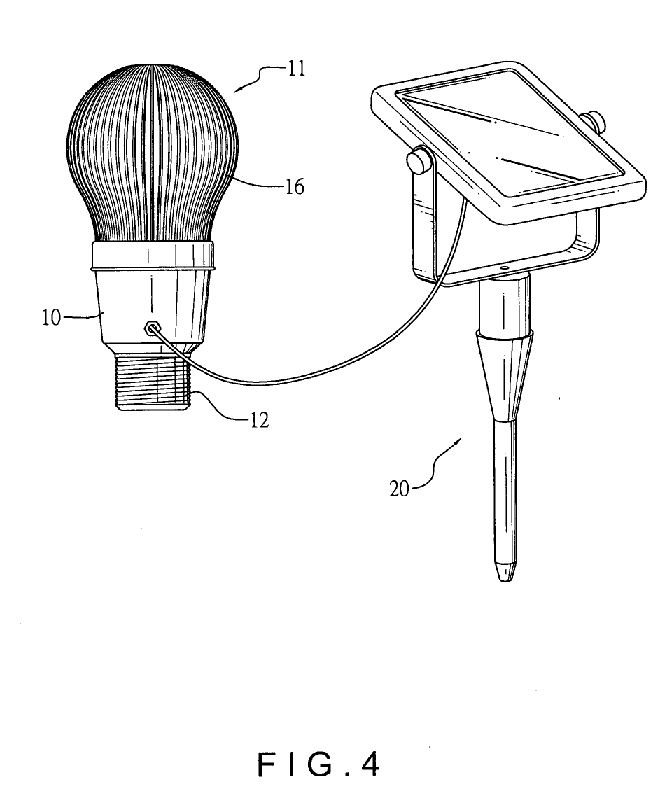

With reference to FIGS. 2, 3 and 4, it is noted that multiple latitudinal grooves (15) are defined in an inner periphery of the bulb covering (11) and multiple light emitting diodes (13) are employed inside the bulb covering (11) and electrically connected to a circuit board (14) which is electrically connected to the LEDs (13) and the annular projection (100).

When the white light bulb assembly of the present invention is electrically connected to a set of solar panels (20) and sited in an appropriate environment, solar energy is supplied to drive the LEDs (13) to illuminate. Due to first reflection and refraction of the light from the LEDs (13) by the latitudinal grooves (15) and second reflection and refraction of the light from the inner circumference of the bulb covering (11), a scattered light pattern is formed so that light is emitted to all directions with the same effect as that of the fluorescent tube. However, the description concerning the longitudinal and latitudinal grooves (16,15) is not to limit the definition of how the longitudinal grooves (16) intersect the latitudinal grooves (15). The intersection between the longitudinal grooves (16) and the latitudinal grooves (15) can be any angle.

The threading (12) formed on the outer circumference of the annular projection (100) allows the white light bulb assembly to be connected to a normal bulb seat (not shown) to avoid the requirement of additional equipment, ie no adapter is required.

Because of the design in the bulb covering (11), compactness in size, great illumination effect and cost effectiveness of the LEDs, the white light bulb assembly is advantageous in use and maintenance.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A white light bulb assembly comprising:
a cylindrical body with an annular projection extending from a bottom face of the cylindrical body;
a bulb covering securely mounted on top of the cylindrical body; and
multiple light emitting diodes provided inside the bulb covering to electrically connect to the annular projection and a circuit board located inside the bulb covering, the bulb covering having multiple first grooves defined in an outer circumference thereof and multiple second grooves defined in an inner circumference thereof to reflect and refract light from the light emitting diodes, the first grooves intersecting the second grooves in an angle.

2. The white light bulb assembly as claimed in claim 1, wherein the annular projection has a threading formed on an outer circumference of the annular projection.

3. The white light bulb assembly as claimed in claim 1, wherein the first grooves are longitudinally defined in the outer circumference of the bulb covering and the second grooves are latitudinally defined in the inner circumference of the bulb covering.

4. The white light bulb assembly as claimed in claim 2, wherein the first grooves are longitudinally defined in the outer circumference of the bulb covering and the second grooves are latitudinally defined in the inner circumference of the bulb covering.
